(19) United States
(12) Patent Application Publication
(10) Pub. No.: US 2002/0115512 A1
(43) Pub. Date: Aug. 22, 2002

(54) Wrapping connector driving device and drive unit provided with wrapping connector driving device

(76) Inventor: Mike Mishler, Schaumburg, IL (US)

Correspondence Address: ARMSTRONG,WESTERMAN & HATTORI, LLP, 1725 K STREET, NW., SUITE 1000, WASHINGTON, DC, 20006, US

(21) Appl. No.: 09/789,932

(22) Filed: Feb. 22, 2001

(51) Int. Cl. F16H 7/00

(52) U.S. Cl. 474/148

(57) ABSTRACT

A wrapping connector driving device for transmitting a rotational motion from a driving shaft to a driven shaft comprises a driving wheel operatively connected to the driving shaft, a driven wheel operatively connected to the driven shaft, a wrapping connector wound around the driving wheel and the driven wheel in a stretched state therebetween, and a bracket which is mounted to an electric motor provided with the driving shaft and a drive device provided with the driven shaft.

The driving wheel is supported to be rotatable to the bracket. The wrapping connector driving device may further comprises a projection member provided for the bracket so as to project inside the driving wheel and a bearing disposed between the driving wheel and the projection member and adopted to support the driving wheel during rotating motion. The bearing is arranged on substantially a central line in a width direction of the wrapping connector. This wrapping connector driving device is effectively mounted to a drive unit such as linear motion guide.

### BACKGROUND OF THE INVENTION

The present invention relates to a wrapping connector driving device and a drive unit provided with this wrapping connector driving device.

Usually, when a rotation (rotational motion) of a driving shaft is transmitted to a driven shaft, there has been used a wrapping connector driving device having a structure that wheels are mounted to both the shafts and a wrapping connector such as belt or rope having a flexible structure, capable of being bent, is stretched around (wound round) both the driving and driven wheels to thereby transmit the rotation of the driving shaft to the driven shaft. As the wrapping connector, there has also been known, for example, V-belt, timing belt, chain or the like.

In a case where a belt, V-belt or rope is utilized as such wrapping connector, the rotation of the driving shaft is transmitted to the driven shaft through frictional force between the driving wheel and the belt, and in such structure, as the belt is pressed around the outer periphery of the wheel, it is required for the belt to have an initial tension to some extent.

Further, in a case where a timing belt or chain is utilized as such wrapping connector, the rotation of the driving shaft is transmitted to the driven shaft through engagement of teeth of a timing pulley with teeth of the timing belt in place of the transmission through the frictional force. In this structure, the rotation can be surely transmitted with no slipping, and since the frictional force is not utilized, it is not required for the timing belt to have the initial tension. However, in such structure, in a case where a rotational angle of the driven shaft is controlled, in order to more surely transmit the rotation of the driving shaft to the driven shaft, it is still required for the timing belt to have a tension to some extent.

As mentioned above, in the conventional wrapping connector driving device, it is basically required for the wrapping connector to have a tension. With this viewpoint, in a prior art, in order to provide the tension to the wrapping connector, a distance between the driving wheel and the driven wheel is made large by moving the driving wheel together with a motor (prime mover). However, the movement of the driving wheel together with the motor involves a difficult working for adjusting the tension, which results in application of excessive tension or less tension.

Furthermore, since a driving (output) shaft of the motor is connected to the driving wheel, a lateral load will be applied to the driving shaft of the motor by the tension of the wrapping connector. Such lateral load will disturb the rotation of the driving shaft, which may cause shaft failures of the motor.

### SUMMARY OF THE INVENTION

An object of the present invention is to substantially eliminate defects or drawbacks encountered in the prior art mentioned above and to provide a wrapping connector driving device capable of not giving a lateral load to the driving shaft of a motor (prime mover) by a tension of the wrapping connector and suitably adjusting the tension of the wrapping connector and also provide a drive unit provided with such wrapping connector driving device.

This and other objects can be achieved according to the present invention by providing, in one aspect, a wrapping connector driving device for transmitting a rotational motion from a driving shaft to a driven shaft, comprising:

a driving wheel operatively connected to the driving shaft;

a driven wheel operatively connected to the driven shaft;

a wrapping connector wound around the driving wheel and the driven wheel in a stretched state therebetween; and

a bracket which is to be mounted to a motor provided with the driving shaft and to a drive device provided with the driven shaft,

wherein the driving wheel is supported to be rotatable by the bracket.

According to this aspect, since the driving wheel is supported by the bracket, the load due to the tension of the wrapping connector is received by the bracket, and hence, no load due to the tension is applied to the driving shaft. Accordingly, no lateral load is applied to the driving shaft of the motor, and thus, the motor can be effectively and smoothly operated.

Moreover, since the driving wheel is supported by the bracket, the tension adjustment can be done before the connection of the driving shaft to the driving wheel. Accordingly, a user can freely mount any type of motor after the tension has been adjusted at the manufacturing firm or the like. Furthermore, since the tension of the wrapping connector is received by the bearing, any lateral load due to the tension is not applied to the driving shaft of the motor. Therefore, a user can use any type of electric motor and mount it easily.

In preferred embodiments of the above aspect, the bracket has a structure movable relative to drive device to thereby adjust a tension of the wrapping connector. That is, for example, the bracket may be formed with a slot to which the drive device is mounted to be movable.

The wrapping connector driving device may further comprises a projection member provided for the bracket so as to project inside the driving wheel and a bearing disposed between the driving wheel and the projection member and adopted to support the driving wheel during rotating motion, and the bearing is arranged on substantially a central line in a width direction of the wrapping connector.

According to the present invention, since the bearing is arranged on substantially a central line in a width direction of the wrapping connector, the load due to the tension of the wrapping connector can be surely received by the bearing.

Furthermore, the projection member is a cylindrical member, the driving wheel is provided with an outer ring contacting the wrapping connector and an input shaft disposed inside the outer ring of the driving wheel so that central axes thereof are coincident with each other, the outer ring is disposed outside the cylindrical projection member, the input shaft is disposed inside the cylindrical projection member, and the bearing is arranged between an outer periphery of the input shaft and an inner periphery of the projection member.

According to the present invention, since the bearing and the projection member holding the bearing are stored inside the driving wheel, the space for arranging the bearing and the projection member is reduced.

The bearing may be a radial bearing.

Accordingly, since the tension of the wrapping connector is received by the bearing, any lateral load due to the tension is not applied to the driving shaft of the electric motor.

The driving wheel is connected to the driving shaft of the motor through a flexible coupling. The wrapping connector is a timing belt and the driven wheel is a timing pulley.

According to this structure, the flexible coupling can absorb eccentricity or deviation, to some extent, between driving and driven axes, so that the lateral load to be applied to the driving shaft can be further reduced, and a user can easily mount the electric motor.

In another aspect of the present invention, there is provided a drive unit including a motor provided with a driving shaft, a drive device provided with a driven shaft and a wrapping connector driving device for transmitting a rotational motion from the driving shaft to the driven shaft, the wrapping connector driving device comprising:

a driving wheel operatively connected to the driving shaft;

a driven wheel operatively connected to the driven shaft;

a wrapping connector wound around the driving wheel and the driven wheel in a stretched state therebetween; and

a bracket which is to be mounted to the motor and the drive device;

wherein the driving wheel is supported to be rotatable by the bracket.

In a preferred embodiment, the wrapping connector driving device further comprises a projection member provided for the bracket so as to project inside the driving wheel and a bearing disposed between the driving wheel and the projection member and adopted to support the driving wheel during rotating motion, and the bearing is arranged on substantially a central line in a width direction of the wrapping connector.

The drive device comprises a track rail having a linear structure, a slide member mounted to the track rail to be linearly movable and a nut member provided for the slide member and screw-engaged with the driven shaft, the nut member and the driven shaft constituting a feed screw mechanism in combination.

According to the drive unit of the structure mentioned above, in addition to the effective merits mentioned above in connection with the wrapping connector driving device, the slide member can be positioned in accordance with a rotational angle of the driven shaft by the location of the feed screw to the drive device.

The nature and further characteristic features of the present invention will be made more clear from the following descriptions made with reference to the accompanying drawings.

### BRIEF DESCRIPTION OF THE DRAWINGS

In the accompanying drawings:

FIG. 1 is a plan view, partially in section, of a driving unit according to one embodiment of the present invention;

FIG. 2 shows a bracket of the driving unit and includes

FIG. 2A being a front view of the bracket,

FIG. 2B being a plan view thereof and

FIG. 2C being a sectional view taken along the line II-II in FIG. 2A;

FIG. 3 is a sectional view of a driving wheel;

FIG. 4 is a plan view of the driving wheel; and

FIG. 5 is a perspective view of a drive device.

### DESCRIPTION OF THE PREFERRED EMBODIMENTS

A preferred embodiment of the present invention will be described hereunder with reference to the accompanying drawings.

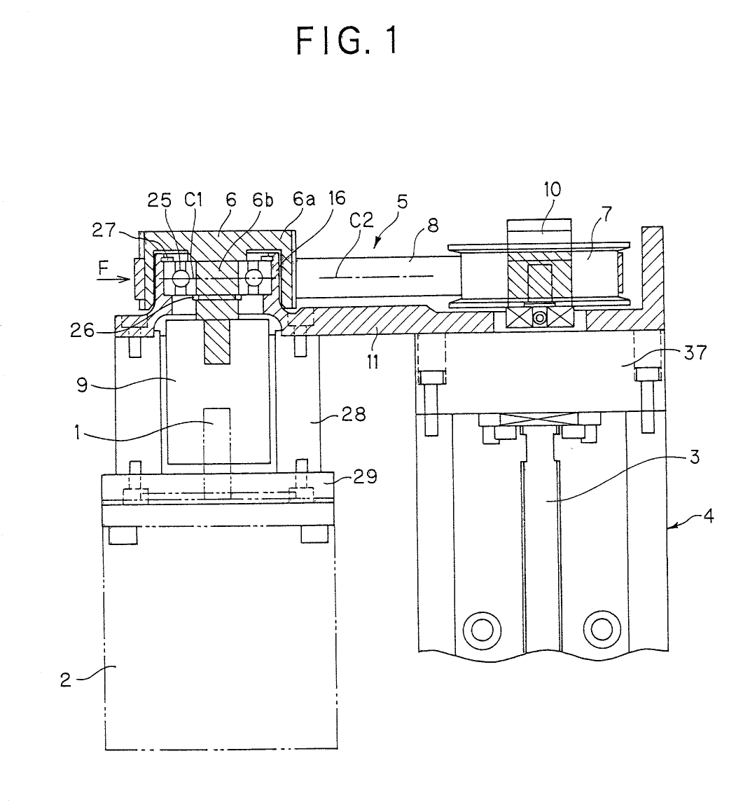

With reference to FIG. 1, showing a drive unit provided with a wrapping connector driving device according to one embodiment of the present invention, a drive unit comprises an electric motor 2 as a prime mover having a driving (output) shaft 1, a drive device 4 provided with a driven shaft 3 and a wrapping connector driving device 5 which transmits a rotation (rotational motion) of the driving shaft 1 to the driven shaft 3.

The wrapping connector driving device 5 comprises a driving wheel 6 mounted to the driving shaft 1, a driven wheel 7 mounted to the driven shaft 3 and a wrapping connector 8 wound round (stretched around) both the driving and driven wheels 6 and 7. In the illustrated embodiment, a timing belt is utilized as such wrapping connector 8, and timing pulleys are utilized as driving and driven wheels 6 and 7. The driving wheel 6 has a structure capable of being coupled to the driving shaft 1 through a flexible coupling 9, and the driven wheel 7 also has a structure capable of being coupled to the driven shaft 3 through a joint 10.

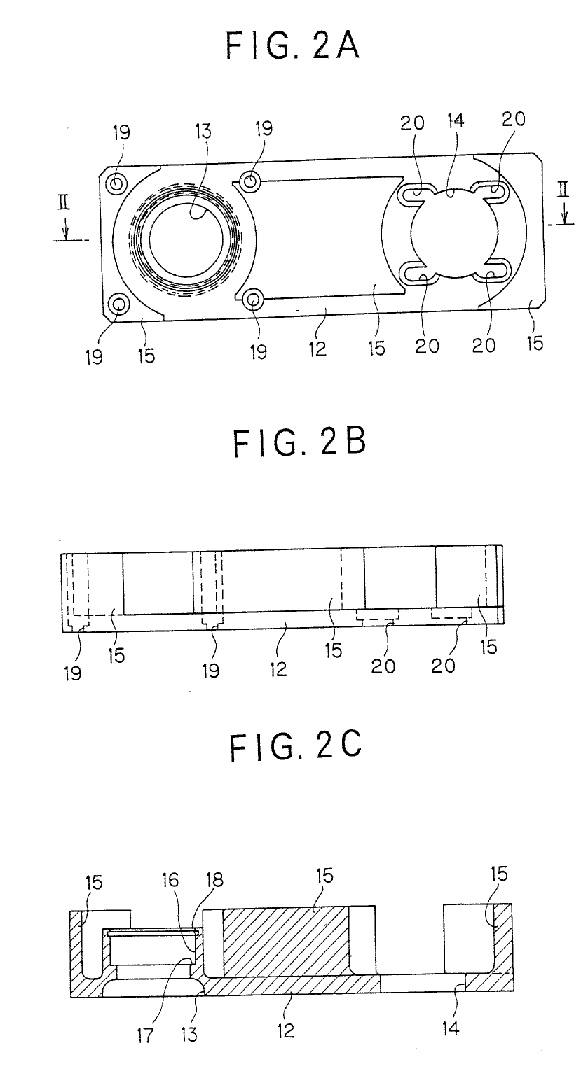

A bracket 11 is secured to the electric motor 2 and the driving device 4 by fastening means such as bolts, and the bracket 11 is shown in FIG. 2.

With reference to FIG. 2 (FIGS. 2A, 2B and 2C), the bracket 11 is formed from a base plate 12 having a rectangular shape to which through holes 13 and 14 are formed for insertion of the driving and driven shafts 1 and 2. The base plate 12 is provided with reinforcing members 15, - - - ,15 for reinforcing the base plate 12 itself at its peripheral and central portions. Furthermore, a cylindrical projection (projecting member) 16 projecting inside the driving wheel 6 is formed to the peripheral portion of the through hole 13 for the driving shaft 1, and a stepped portion 17 and a ring fitting groove 18 are formed to the inner peripheral portion of the projection 16 so that an outer ring of a bearing is fitted thereto as described hereinlater.

As shown in FIG. 2A, holes 19, - - - , 19 for mounting and fixing the electric motor 2 to the bracket 11 are formed to the peripheral portions of the through hole 13 formed to the base plate 1. And holes 20, - - - , 20 for mounting and fixing the driving device 4 to the bracket 11 also formed to the base plate 1. Further, the mounting holes 20, - - - , 20 are formed as long holes (slots) so that the driving device 4 is relatively movable with respect to the bracket 11.

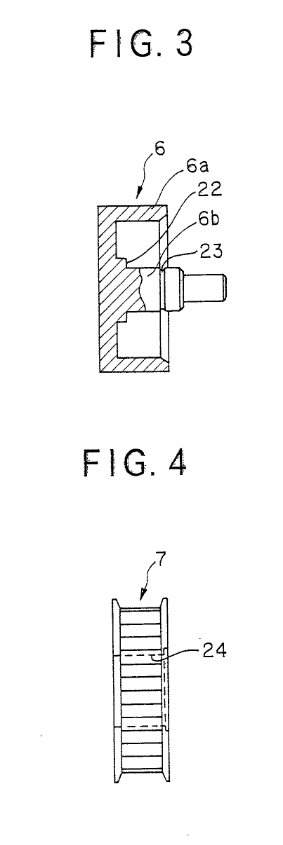

FIG. 3 shows the driving wheel 6, which comprises an outer ring 6a contacting the wrapping connector 8 and an input shaft 6b which is disposed inside the outer ring 6a and to which the flexible coupling 9 is connected. The outer ring 6a and the input shaft 6b have a common central line (axis). The outer ring 6a is formed, at its outer peripheral surface, with teeth meshed with the timing belt. The input shaft 6b is formed with a stepped portion 22 and a ring groove 23 for the mounting of an inner ring of a bearing which will be described hereinlater.

FIG. 4 shows the driven wheel 7 having an approximately cylindrical appearance and formed, at its outer peripheral surface, with teeth meshed with the timing belt. An insertion hole 24, where the joint 10 for coupling the driven wheel 7 to the driven shaft 3 is inserted, is formed to the inner peripheral surface of the driven wheel 7.

With reference to FIG. 1, a bearing 25 composed of a radial bearing is disposed between the driving wheel 6 and the projection of the bracket 11 so as to serve as a member for supporting the input shaft 6b of the driving wheel 6 carrying out rotational motion. The bearing 25 has an axial central line C1 coincident with a central line C2 of the wrapping connector 8 in the width direction thereof. According to such arrangement, a force F due to the tension of the wrapping connector 8 is applied as a load to the bearing 25. Further, in this arrangement, the outer ring 6a of the driving wheel 6 is positioned outside the projection 16 and the input shaft 6b thereof is positioned inside the projection 16. The bearing 25 is arranged between the outer periphery of the input shaft 6b of the driving wheel 6 and the inner periphery of the projection 16 in a manner such that the bearing 25 is clamped between an inner retainer ring 26 mounted to the input shaft 6b and an outer retainer ring 27 mounted to the projection 16.

The electric motor 2 is mounted to the bracket 11 through a motor adapter 28 and a motor adapter flange 29. The driving shaft 1 of the electric motor 2 and the input shaft 6b of the driving wheel 6 are aligned on the same straight line and coupled together through the flexible coupling 9 disposed inside the motor adapter 28.

The driving device 4 is also attached to the bracket 11 so that the central line (axis) of the driven shaft 3 of the driving device 4 and that of the driven wheel 7 are aligned on the same line and the driven shaft 3 and the driven wheel 7 are operatively connected through the joint 10.

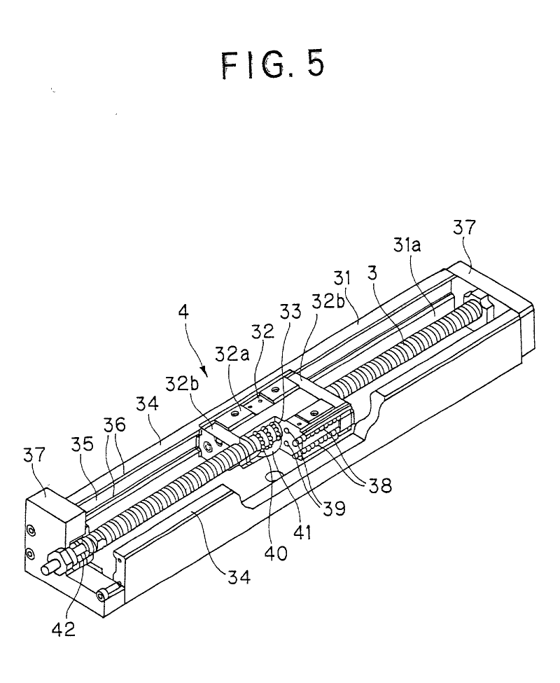

FIG. 5 shows the driving device 4, which comprises a track rail 31 secured to the bracket 11, a slide member 32 guided along the track rail 1 to be linearly freely movable and a nut member 33 provided for the slide member 32 and screwed with the driven shaft 3. The driven shaft 3 has an outer peripheral surface on which a screw groove is formed, which constitutes a feed screw mechanism in combination of the nut member 33.

The track rail 31 has a box-shaped section having an upper opening (recessed side) 31a such as shown in FIG. 5. That is, the upper opening 31a of the track rail 31 is defined by a pair of ridges 34, 34 extending in parallel to each other at both longitudinal ends of the opening 31a. Recessed grooves 35, 35 are formed to both the inner side surfaces of the ridges 34, 34, respectively. Furthermore, two rows of ball rolling grooves 36, 36 are formed to upper and lower corner portions of each of the recessed grooves 35, 35. Both the longitudinal end portions of the track rail 31 are closed by end plates or end covers 37, 37, one of which is secured to the bracket 11.

The slide member 32 comprises a block body 32a and end plates 32b attached to both longitudinal end portions of the block body 32a. The slide member 32 is inserted into the upper opening 31a of the track rail 31 and supported between both the ridges 34, 34 so as to be clamped therebetween through balls 38, —, 38 as rolling members.

Loaded rolling grooves are formed to both side surfaces of the block body 32a so as to oppose to the ball rolling grooves 36 of the track rail 11, respectively, and a number of balls 38 are accommodated between the opposed ball rolling grooves 36 and loaded rolling grooves to be rollable therebetween. Furthermore, the block body 32a is formed with ball escape holes 39, 39 for returning the balls 38 rolling in the loaded area so as to extend in parallel to the loaded rolling grooves. The end plates 32b, 32b disposed both end portions of the block body 32a are formed with ball return passages, respectively, so as to scoop up and then return the balls in the loaded area to thereby circulate the balls 8 again in the loaded area.

As mentioned hereinbefore, the nut member 33 screw-engaged with the driven shaft 3 is provided at the central portion of the block body 32a, and a loaded rolling groove in a spiral shape is formed to the nut member 33 so as to face the spiral ball rolling groove formed to the driven shaft 3. A number of balls 40, - - - , 40 as rolling members are also arranged between these spiral ball rolling groove and the spiral loaded rolling groove to freely roll and move therebetween. The nut member 33 is further provided with a return tube 41 through which the balls rolling in the loaded area circulate.

The driven shaft 3 is supported at its both ends by the end plates 37, 37 so as to allow the driven shaft 3 performs only rotational motion by means of bearing 42. As mentioned before, one end of the driven shaft 3 is operatively coupled to the driven wheel 7 through the joint 10.

The driving unit of the structure mentioned above will operate in the following manner.

When the electric motor 2 is driven, the driving shaft 1 is rotated, and this rotational motion is transmitted to the driving wheel 6 coupled to the driving shaft 1 through the flexible coupling 9, thus rotating the driving wheel 6. The rotation of the driving wheel 6 is then transmitted to the driven wheel 7 through the wrapping connector 8, and when the driven wheel 7 is rotated, the slide member 32 is moved linearly along the track rail 31 through the engagement with the feed screw.

The rotating driving wheel 6 is supported by the bearing 25, which is disposed on the central line in the width direction of the wrapping connector 8. For this reason, a load caused by the tension of the wrapping connector 8 is received by the bearing 25, and hence, a load due to the tension of the driving shaft 1 is not applied. Accordingly, the driving shaft 1 of the electric motor 2 is not applied with a lateral load due to the tension, and the driving shaft 1 can be hence smoothly driven and rotated.

Next, the tension adjusting method or manner of the tension of the wrapping controller driving device 5 will be described.

Only the drive device 4 is first mounted to the bracket 11 before the mounting of the electric motor 2 to the bracket 11. Next, the bracket 11 is moved relatively to the drive device 4. Since the driven wheel 7 is connected to the drive device 4, the driven wheel 7 is also moved relatively to the bracket 11 through the relative movement between the bracket 11 and the drive device 4. On the other hand, since the driving wheel 6 is supported by the bracket 11, the position thereof is not changed. Accordingly, the distance between the driving wheel 6 and the driven wheel 7 changes, whereby the tension of the wrapping connector 8 can be adjusted.

Since the driving wheel 6 is supported by the bracket 11, such tension adjustment can be done before the connection of the driving shaft 1 of the electric motor 2 to the driving wheel 6. Accordingly, a user can freely mount any type of electric motor 2 after the tension has been adjusted at the manufacturing firm or the like. Furthermore, since the tension of the wrapping connector 8 is received by the bearing 25, any moment load due to the tension is not applied to the driving shaft 1 of the electric motor 2. Accordingly, a user can use any type of electric motor and mount it easily.

It is to be noted that the present invention is not limited to the described embodiment and many other changes or modifications may be made without departing from the scopes of the appended claims.

For example, in the described embodiment, the belt connector (transmission) driving device is utilized, another device such as chain or rope connector (transmission) driving device may be instead utilized.

What is claimed is:

1. A wrapping connector driving device for transmitting a rotational motion from a driving shaft to a driven shaft, comprising:
a driving wheel operatively connected to the driving shaft;
a driven wheel operatively connected to the driven shaft;
a wrapping connector wound around the driving wheel and the driven wheel in a stretched state therebetween; and
a bracket which is to be mounted to a motor provided with the driving shaft and to a drive device provided with the driven shaft,
wherein said driving wheel is supported to be rotatable by the bracket.

2. A wrapping connector driving device according to claim 1 wherein said bracket has a structure movable relative to drive device to thereby adjust a tension of the wrapping connector.

3. A wrapping connector driving device according to claim 2, wherein said bracket is formed with a slot to which the drive device is mounted to be movable.

4. A wrapping connector driving device according to claim 1, further comprising a projection member provided for the bracket so as to project inside the driving wheel and a bearing disposed between the driving wheel and the projection member and adopted to support the driving wheel during rotating motion, said bearing being arranged on substantially a central line in a width direction of the wrapping connector.

5. A wrapping connector driving device according to claim 4, wherein said projection member is a cylindrical member, said driving wheel is provided with an outer ring contacting the wrapping connector and an input shaft disposed inside the outer ring of the driving wheel so that central axes thereof are coincident with each other, said outer ring is disposed outside the cylindrical projection member, said input shaft is disposed inside the cylindrical projection member, and said bearing is arranged between an outer periphery of the input shaft and an inner periphery of the projection member.

6. A wrapping connector driving device according to claim 4, wherein said bearing is a radial bearing.

7. A wrapping connector driving device according to claim 1, wherein said driving wheel is connected to the driving shaft of the motor through a flexible coupling.

8. A wrapping connector driving device according to claim 1, wherein said wrapping connector is a timing belt and said driven wheel is a timing pulley .

9. A drive unit including a motor provided with a driving shaft, a drive device provided with a driven shaft and a wrapping connector driving device for transmitting a rotational motion from the driving shaft to the driven shaft, said wrapping connector driving device comprising:
a driving wheel operatively connected to the driving shaft;
a driven wheel operatively connected to the driven shaft;
a wrapping connector wound around the driving wheel and the driven wheel in a stretched state therebetween; and
a bracket which is to be mounted to the motor and the drive device;
wherein said driving wheel is supported to be rotatable by the bracket.

10. A drive unit according to claim 9, wherein the wrapping connector driving device further comprises a projection member provided for the bracket so as to project inside the driving wheel and a bearing disposed between the driving wheel and the projection member and adopted to support the driving wheel during rotating motion, said bearing being arranged on substantially a central line in a width direction of the wrapping connector.

11. A drive unit according to claim 9, wherein said drive device comprises a track rail having a linear structure, a slide member mounted to the track rail to be linearly movable and a nut member provided for the slide member and screw-engaged with the driven shaft, said nut member and said driven shaft constituting a feed screw mechanism in combination.

12. A drive unit according to claim 9, wherein said wrapping connector is a timing belt and said driven wheel is a timing pulley.
